(19) United States
(12) Patent Application Publication
(10) Pub. No.: US 2018/0013800 A1
(43) Pub. Date: Jan. 11, 2018

(54) SYSTEMS AND METHODS FOR ENABLING DIALOG AMONGST DIFFERENT PARTICIPANT GROUPS WITH POST-LEVEL QUALIFIERS

(71) Applicant: Rushline, LLC, Scottsdale, AZ (US)

(72) Inventors: Daniel Morrison, Scottsdale, AZ (US); Martin Sielaff, Chandler, AZ (US); Todd Fletcher, Mesa, AZ (US)

(73) Assignee: Rushline, LLC

(21) Appl. No.: 14/595,853

(22) Filed: Jan. 13, 2015

(51) Int. Cl. H04L 29/06; G06F 3/0484; G06F 17/30; H04L 29/08

(52) U.S. Cl. CPC H04L 65/403; H04L 67/26; G06F 3/04847; G06F 17/30864

(57) ABSTRACT

An electronic communication service, such as a question-and-answer service, is provided in which content contributions include post-level qualifiers to demonstrate, e.g., level of expertise in the subject matter of each contribution. User views of dialog content may be based on post-level qualifier content and/or the content contributor's association with the viewer or dialog initiator. The service can implement hierarchical association groups to enable overlapping dialog with shared and unique content.

### TECHNICAL FIELD

The present disclosure relates in general to data processing techniques, and in particular to systems and methods for network-based dialog amongst multiple participants using post-level qualifiers.

### BACKGROUND

Electronic communication is a method for exchanging digital messages and information amongst multiple individuals. Electronic communication may operate across the Internet or other electronic communication networks. Examples of electronic communication include email, Short Messaging Service (SMS) communication, Multimedia Messaging Service (MMS) communications and web-based applications facilitating conveyance of information using a web browser.

Electronic communications have become a primary method by which people communicate information. One form of electronic communication that has become particularly popular is online question-and-answer services. In general, a question-and-answer service is a service that allows its end users to post questions, post answers to questions, and/or view answers to questions that others have posted. In some systems, ongoing dialog can occur amongst multiple participants and users contribute content and respond to content contributed by others. Thus, at a basic level, Q&A services primarily act to store, organize and facilitate the distribution of user-generated content. In some systems, Q&A services provide a higher-level function, facilitating highly valued knowledge sharing and discovery as individuals from around the globe contribute their detailed knowledge and opinions on topics as wide and deep as the minds of those participating. However, after 35 years and what likely amounts to thousands of efforts to unlock mass collaboration, beginning with BBS systems in 1978 and Usenet in 1980, continuing today through various forums and community sites, Q&A services remain a niche service, actively participated in by a small fraction of the online population, leaving the vast majority of potential knowledge sharing unrecognized.

In many modern question-and-answer services, users ask questions to a predefined community of users registered with the service. Often, questions are organized within predefined topics in order to aggregate users having a common interest in the subject matter. After a question is submitted, the asker waits for qualified members to see the question, and hopefully, respond with a relevant, informative and accurate response.

Existing Q&A models present participants and system designers with a number of challenges. Amongst those challenges are: (1) assessing the quality or value of an individual post from a community member; (2) avoiding the presentation of poor or irrelevant content to readers and potential participants, and showing only the highest quality and/or most relevant content; (3) getting qualified strangers to answer questions; and (4) increasing the level of discourse around complex subject matter.

1. Assessing the Quality or Value of an Individual Post from a Community Member

Commonly in communities, anyone can post, whether they are highly qualified as in the case of a surgeon discussing a procedure she has done for 25 years, or whether they have no practical experience but want to share their opinion as in the case of a mother of three answering a question seeking scientific proof whether child immunizations may cause autism, despite having no education, experience or research studies supporting her comment. Some people posting to community sites may even state their unfounded opinions as if they are proven facts without recognizing the confusion that may cause.

This leads to a wide range of quality, and frequently results in a high volume of low quality posts from responders that may be unqualified from the subjective viewpoint of the asker. The mix of high and low value posts may be described as signal (high quality) to noise (low quality) ratio. As the signal to noise ratio goes up, the value viewers and community members receive for their time goes up. Conversely, as this ratio goes down and noise becomes prevalent, value diminishes. The commonly low signal to noise ratio at many community sites may cause people to avoid using these sites or from trusting community content.

Because anyone can post, a reader is left to discern who is trustworthy, as in the doctor above, and who is not, as in a person posting based on unfounded opinions or anecdotal evidence of questionable validity. These issues have a multiplicative detrimental effect by turning users away from those community sites, taking their bases of knowledge with them where they will never be shared with the community.

One way community operators attempt to manage this quality challenge is through mechanisms that help readers assess the value of content they are seeing. Many existing systems allow readers to vote for helpful content or against unhelpful content. These votes may be tallied and appear with meta-data about the post. In some services, posts that receive higher ratings show up ahead of posts receiving lower ratings.

While these voting systems help to a certain degree, they have limitations. What one person thinks is a good post is subjective based on their own experience level and opinions, opinions that are subjective and may be unlike the opinions of future readers. Other times, top voted content may be indicative of the least-bad option from a series of poor posts rather than indicating a truly accurate or helpful post.

Further, communities are often formed of like-minded people, which can skew the results of voting systems. For instance, strict followers of naturopathic medicine and vegan diets might down-vote almost anything suggesting a remedy based on western medicine and might up-vote almost any recommendation stating a certain herbal remedy is superior and highly effective. Similarly, a community of traditional Western medical doctors might down-vote an effective herbal remedy and up-vote a high-powered pharmaceutical product about which they were recently educated through an aggressive manufacturer sales campaign.

Critically, “point systems” and other voting systems are viewed by some potential contributors as hokey or undesirable because they don't want to subject themselves to the judgments of other, possibly less qualified, viewers. Also, many people do not want to subject themselves to the reputation risk of a low rated post resulting from the favor of answering someone's (potentially even a stranger's) question.

All of these issues are likely to reduce the number of people willing to share their knowledge, reducing the amount of knowledge the community has access to and thus reducing the value of such communities as a whole.

Another problem with content voting is that it takes time to collect enough votes to impart meaning. Some niche posts viewed by a small number of readers may never get enough votes to accurately reflect content quality, while others may require days or weeks, and by then, the conversation is over. Due to the time lag, voting systems provide little secondary value as a means for linking people to currently active conversations of a certain quality quickly enough to participate in those conversations themselves.

Thus at best, content voting may present some indicator of post quality, but often delayed, of questionable accuracy, and of little help to winning over many people skeptical of community-based content.

Yet another way some services attempt to call out higher quality posts is to let the asker choose their favorite answer. This “chosen answer” method to qualifying content of value is subject to similar limitations as viewer voting, where the person choosing may have limited knowledge themselves or may have an opinion far different from that of a future reader. This technique also gives a sense of “picking favorites” that may inherently suggest a post is of poor quality if it is not the one chosen—again potentially being viewed as a game or popularity contest that potential participants may choose to avoid subjecting themselves to.

A different existing method of indicating the value of individual posts in a Q&A site is to qualify the author. The underlying assumption is the higher the qualification, the more likely the author's posts are to be accurate and useful. This implementation often includes giving people special designation with their posts (e.g. “Community Expert” or “xxxx number of points or xxx thank yous or xx number of posts”). While this often provides some value in deciphering post quality, it may also have critically limiting effects on a community.

Author point systems and special designations within a community may make the community seem competitive or even hokey to many qualified people who are put off by the idea of subjecting themselves and their reputations to being weighed and measured by strangers, while constantly fighting to keep their reputation up. These people may prefer to not bother with, and may frown upon, such systems.

Another way to qualify the author is to build up their biographical profile information, including topics they are skilled in and to what level. This usually imposes a significant burden on each user to set up and keep current, limiting the number of people willing to participate. It may be impractical or unduly burdensome to maintain a comprehensive global profile in a system addressing diverse subject matter, given the number of potential topics a user might comment on, while having vastly different qualifications from one topic to the next.

Further, while biographical data may yield useful metadata, it may be of little value at the level of an individual post. For example, while a tenured surgeon may have a great deal of experience performing a medical procedure using a certain technique, he may have little or no experience performing the procedure via another technique. Relying on biographical metadata to identify that surgeon's qualification may result in him looking like an expert when posting on either procedure, including the procedure for which he has no experience.

The collection and display of meta-biographical-data has other shortcomings. For instance, metadata changes over time. The content author's current profile metadata showing up next to a post they made long ago may not be indicative of the experience they had at the time of the post, and someone reading that post and biographical data might be misled regarding the qualifications of the content contribution. A reader may be led to believe that the contributor was not forthright about their experience level—not realizing that the contributor's biographical metadata had changed since the time the post was made. Further, as a person's knowledge and experiences inevitably change over time, the burden of managing their biographical metadata increases. As a result, metadata often becomes outdated and misleading.

In other implementations, used by services such as Quora, a content author may enter free form text describing their qualifications with each post they make. This may present value to a future reader, but the subjective, free form, and arbitrary nature of the qualifier may lead to inaccurate or inconsistent qualifying descriptions that provide little meaning to a casual reader. Further, since these fields are free form, their ability to be leveraged for future filtering is extremely limited.

The issues outlined above and the user burdens that go with them often add up to fragmented quality indicators of questionable value while also working to discourage some potential participants from contributing.

2. Avoiding the Presentation of Low Quality or Irrelevant Content

Commonly, anyone can post in communities, and active communities tend to receive a high volume of posts across a wide spectrum of opinions and experience levels. As a result, a problem that arises is a high volume of content of low value to many readers or community participants, especially when displayed in an unfiltered manner. A user arriving at a general Q&A site might be presented with a long list of recent threads that are topically irrelevant to them and might also be of low quality.

This causes many people to distrust or avoid community content in general. For others, it may simply discourage them from participating as a posting member, even if they occasionally visit to read content. This in turn reduces the potential for knowledge sharing since those peoples' knowledge is excluded from the service.

One way existing systems attempt to display relevant content to each user is by dividing into niche forums or groups. Under these systems, users are displayed content on narrow topics, thus increasing the likelihood that what they see will be of interest to them. However, the issue of varying experience levels and subjective opinions continues to exist and many users are not willing to take time to parse through a large amount of content to find posts that contain value.

Similarly, most services allow a user to search the community's content using specific terms that will hopefully reveal content of the greatest value to the user. The service might go a step further and combine content voting or author qualifications in the search algorithm in an effort to display results having the highest value first. Even in this scenario, a user has to take the action of performing a search and many users have already decided to leave for reasons outlined above. When searches are performed using an algorithm to prioritize content rated highest, they still contain many of the limitations with voting and qualification systems outlined previously. While some users are willing to put in the effort to sort through content to discern what is useful, many are not.

In an effort to filter out noise and show only higher value content, some services prioritize content based on voting and author qualification systems outlined above, sometimes displaying only the highest rated content and hiding the rest until a user requests to see it. Again, these services inherit limitations of the voting and qualification systems on which they are based, and are often of limited effect as a result.

3. Getting Qualified Strangers to Answer Questions

One of the most profound capabilities introduced by the Internet is the potential to quickly link strangers together to solve problems. Many problems that arise have been faced by someone else somewhere in the world, often in the same or a similar context. Therefore, tested solutions to many problems exist as well. However, until the Internet became a mainstream phenomenon, there were few realistic ways to link someone having a problem today with someone or some people who solved it, or a very similar problem, previously.

In addition to enabling problem solving, the concept of linking like-minded people together enhances the prospects for new knowledge discovery. Collaboration has always been a powerful tool for science and research, as well as opinion formation and political debate. Prior to the Internet, this collaboration was primarily limited to people in the same physical location or it was drawn out by logistics, greatly restricting results. Now, collaborative discovery can happen on a global scale with almost anyone participating, nearly instantly.

But again, significant challenges are faced in getting all the people with relevant and useful knowledge on any given topic into the same collaboration system, linking the right people together in that system at the right time, and encouraging them to become willing to share their knowledge. If these challenges could be overcome on a mass-scale to include a majority of the online population, the rate of knowledge transfer and discovery would be staggering in comparison to anything that has existed before. However, prior systems fall far short of that potential, with participation in such sites limited to a small fraction of the online population.

While some systems, such as Wikipedia, have succeeded in enabling enough knowledge sharing that hundreds of millions of people benefit, those systems rely on a proportionately small number of participants to provide that knowledge (according to Wikipedia's about page, 2012 saw 470 million unique monthly visitors with 0.016% being “active contributors”). Thus, the concept of linking the right strangers to the right people at the right time plays little significance and the problems that can be solved are therefore different from those based on mass collaboration from significant portions of the online population.

In an effort to get a greater number of people joining these collaborative systems and actively participating, other knowledge sharing systems organize participants around niche topics, with the hope that common interests will keep people coming back regularly. One reason this is important is because in order for an asker's question to be answered soon enough be useful to them, it must be seen promptly by the right potential answerer(s).

An approach that many, if not most, existing knowledge sharing communities employ is to maximize the number of times people visit, especially people capable of answering a lot of topical questions. One problem with this is people are busy and unlikely to come by several times a day to see if someone has posted a question they can help with. One of the reasons sites attempt to create experts or champions is to keep enough capable people visiting often enough to answer most questions that come up within a reasonable timeframe. However, this model is inherently limited by the small number of people willing to contribute all this time and effort to help others, and thus falls far short of getting the majority of the Internet's population plugged in and participating.

Another method many sites have utilized is getting users to sign up to push notifications so they see relevant questions very soon after they are posted, increasing the chances the question will quickly get seen by as many potentially relevant people as possible. These notifications are usually based on an individual topic (e.g. as in joining a discussion group or mail list specifically about Ford F-150 trucks), or based on a user's social network or other personal connections (e.g. get notified whenever someone in your network posts something). Due to the generalized nature of these notifications, and the lack of likelihood that others in that group are having the same information needs as the notified user on any given day, these notifications usually include a lot of noise and little signal. As a result, many users turn such notifications off. Even in the more successful services built around push notifications, such as e-mail based listservs, active participants tend to fatigue of the volume of messages over time, eventually opting-out.

Overcoming limitations of these techniques in encouraging Q&A system users to promptly and reliably answer questions of others may serve to greatly improve knowledge transfer and discovery amongst different people.

4. Increasing the Level of Discourse Around Complex Subject Matter

Internet-based communications systems have greatly increased opportunities for broad cross-sections of people to interactively communicate regarding complex and important subject matter. For example, many news stories are published on sites implementing comment systems, such as Disqus™ or LiveFyre™ Community Comments, in which readers can post their own thoughts and opinions about the story. However, important or provocative stories frequently result in high volumes (often thousands or even tens of thousands) of comments that lack order and organization. As a result, many users may skim or sample comment content, while large volumes of comment content that could be potentially more interesting to the reader remain undetected. Other systems, such as Twitter™, include social network features and hashtag referencing systems, but remain largely unstructured and typically impose strict limits on contribution size, such as 140 characters. As a result, existing systems may be limited in their capability to effectively enable discourse for a broad audience around complex or controversial subject matter that will elicit many community posts from widely varied perspectives.

Improving the ability of an electronic network-based communication system to address some or all of the above-mentioned challenges, or other challenges and limitations of existing systems, may result in a dramatic increase in value provided to users.

### SUMMARY

The present disclosure describes systems and methods for electronic communications amongst numerous individuals, in which dialog contributions include post-level qualifiers. The system can be implemented on one or more network-connected servers communicating with a plurality of user devices via one or more digital communication networks, such as the Internet and cellular networks. Dialog content can be presented via, e.g., a web site, a user-installed application, or directly within notifications.

In accordance with one aspect, delimited post-level qualifiers can, amongst other things, help users assess the quality or value of content posts. Servers receive opening dialog content, and responses to the opening content. Each response includes substantive content, and a post-level qualifier describing, e.g., the respondent's personal level of experience or other qualification relative to the substantive content. The post-level qualifier is preferably selected by the respondent from amongst a plurality of pre-determined options. Preferably, post-level experience qualifier options are organized in an ordered sequence.

The post-level qualifiers can be used to control a user's view of dialog content to, for example, avoid presenting content that a viewer considers lower quality or irrelevant. The user can specify a minimum level for a post-level qualifier. The servers can then publish the opening dialog content and a subset of responses, with the subset of responses being determined based on, amongst other things, the post-level qualifier associated with each response. Other criteria that can be used to filter content provided within a viewer's content view include the content contributor's pre-existing association with the viewer, such as social network relationships, prior dialog between users, and common biographical information. A viewer user interface can be provided with one or more user interface elements, such as a slider control, to dynamically adjust content view by altering view filter criteria, enabling the user to narrow or broaden their view of discussion content.

In some embodiments, an opening user can specify recipients to whom the opening dialog content is to be communicated. The post-level qualifiers can include an experience level qualifier, and/or a custom qualifier. The nature of the custom qualifier and options for response can be determined by the opening user. Recipients must then respond to each of the post-level qualifiers when contributing substantive content to the dialog.

In accordance with another aspect, users can configure content discovery settings to identify desired dialog contributions. Such content discovery settings can potentially encourage greater levels of participation by promptly notifying users of ongoing conversations and new content of interest. The content discovery settings include substantive content criteria and a qualification level criterion, such as a threshold experience level qualifier. Content discovery settings can be utilized by a dialog linker to connect users with active dialogs of interest to them on an ongoing basis, whereby the system monitors ongoing conversations to determine when something of interest to another user is posted based on, e.g., substantive content criteria and the qualification or experience-level criterion. Content discovery settings can also be used to implement a search functionality whereby users can query a database of dialog contributions, with the query results limited by and/or prioritized by experience level qualifier settings associated with each dialog contribution.

In accordance with another aspect, an Internet message board service is provided to, amongst other things, facilitate group discourse around complex subject matter by implementing parallel inheriting conversations. Content contributions can be received from users affiliated with hierarchical association groups. By default, the service publishes a content view to members of a first-level association group that include content contributions from members of the first-level association group, but excludes content contributions from members of a second-level association group. The service publishes a default content view to members of the second-level association group that includes content contributions from members of the first-level association group as well as content contributions from members of the second-level association group. Similarly, third- and greater-level association groups can be implemented, in which each group's default view includes content contributions from others belonging to an equal or higher level association group. Thus, the view published to a user device can include content contributions from a subset of association groups, the subset determined based on the hierarchical relationship of each association group to a view threshold level. Preferably, the view threshold level can be controlled by the user, such as via a slider user interface element.

Various other objects, features, aspects, and advantages of the present invention and embodiments will become more apparent from the following detailed description of preferred embodiments, along with the accompanying drawings in which like numerals represent like components.

### BRIEF DESCRIPTION OF THE FIGURES

FIG. 1 is a schematic block diagram of a question-and-answer communications system and environment, in accordance with a first embodiment.

FIG. 2 is a schematic block diagram of participants in a Q&A dialog.

FIG. 3 is a process for Q&A communications.

FIG. 4 is a user interface for answering a question, in accordance with one embodiment.

FIG. 5 is a process for answering a question in an online Q&A system using an experience post-level qualifier.

FIG. 6 is a user interface for answering a question in an online Q&A system, using custom post-level qualifiers.

FIG. 7 is a user interface for viewing Q&A content using experience post-level filtering.

FIG. 8 is a user interface for viewing Q&A content using custom post-level qualifier filtering.

FIG. 9 is a process for determining content view using a user-controlled zoom mechanism.

FIG. 10 is a user interface for viewing Q&A content using a user-controlled zoom mechanism.

FIG. 11 is a block diagram of dialog content with multiple association-based views.

FIG. 12 is a diagram of a dialog with multiple sub-dialogs, having overlapping association-based views.

FIG. 13 is a user interface for configuring notifications based on association, experience post-level qualifiers and custom post-level qualifiers.

FIG. 14 is a flowchart of a process for configuring notifications based on content discovery settings configured via the user interface of FIG. 13.

FIG. 15 is a flowchart of a process for searching a database of dialog contributions using content discovery settings such as those specified in FIG. 13.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Systems and methods described herein may present key attributes and capabilities that help overcome limitations of prior systems to enfranchise large portions of the Internet population as active participants in knowledge sharing and discovery. Specifically, the systems and methods described herein address challenges common to Q&A services and other electronic communication systems, such as a) content quality, b) signal to noise ratio, c) quickly linking strangers together to solve problems of common interest, and d) structuring complex conversations. To the extent these challenges are addressed by existing systems, such systems often help on one front, while imposing secondary effects that simultaneously limit the number of people willing to participate.

From the perspective of its end users, the value of a question-and-answer service depends significantly on multiple factors. Such factors may include: how convenient it is to post a question; the extent to which users receive accurate, insightful and meaningful answers to their questions; the timeliness in which users receive answers to their questions; the ease with which users can contribute answers to the system; the extent to which spam and unhelpful content contributions can be minimized; the extent to which users may avoid reputation risk and undesired or inadvertent sacrificing of user privacy; and the extent to which users can easily locate and view previous useful conversations other people have had on the topic of their questions.

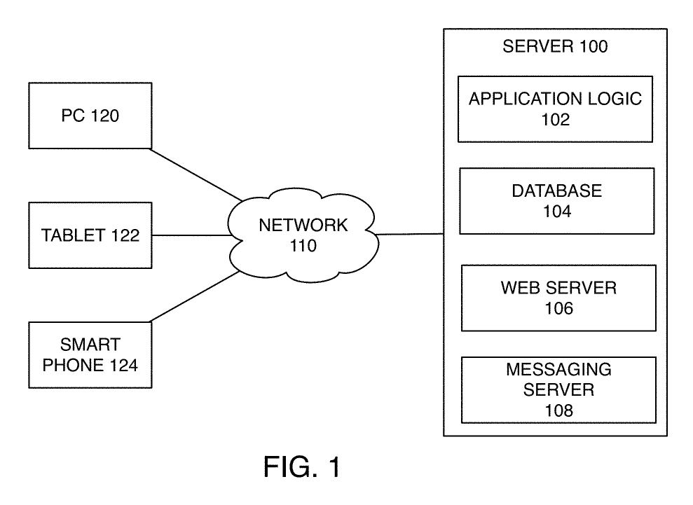

FIG. 1 is a schematic block diagram of an embodiment of a question-and-answer communications system. Server 100 communicates, inter alia, via computer network 110, which may include the Internet, with user devices such as personal computer 120, tablet computer 122 and smart phone 124. Server 100 implements application logic 102, and operates to store information within, and retrieve information from, database 104. The term “database” is used herein broadly to refer to a store of data, whether structured or not, including without limitation relational databases and document databases. Web server 106 hosts one or more Internet web sites enabling outside user interaction with, amongst other things, application logic 102 and database 104. Messaging server 108 enables instant messaging, such as SMS or MMS communications, between server 100 and user devices 120, 122 and/or 124.

While depicted in the schematic block diagram of FIG. 1 as a block element with specific sub-elements, as known in the art of modern web applications and network services, server 100 may be implemented in a variety of ways, including via distributed hardware and software resources and using any of multiple different software stacks. Server 100 may include a variety of physical, functional and/or logical components such as one or more each of web servers, application servers, database servers, email servers, storage servers, SMS or other instant messaging servers, and the like. That said, the implementation of server 100 will include at some level one or more physical servers, at least one of the physical servers having one or more microprocessors and digital memory for, inter alia, storing instructions which, when executed by the processor, cause the server to perform methods and operations described herein.

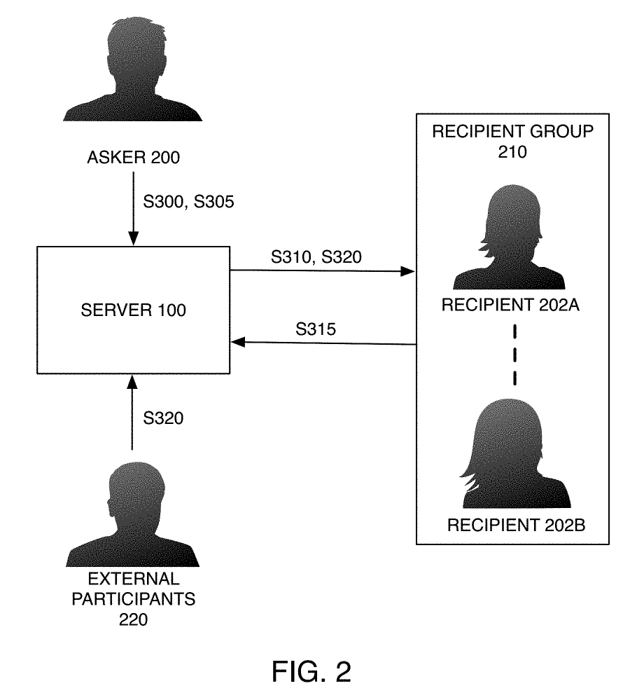

The communication system of FIG. 1, executing application logic 102, can be utilized to implement question-and-answer communication services amongst the individuals illustrated in FIG. 2. Such individuals include asker 200, recipient group 210 which includes one or more recipients 202, and one or more external participants 220. Recipient group 210 is comprised of individuals who are configured to receive outbound messages from server 100, such as push notifications, notifying them of some or all questions submitted by asker 200. The composition of recipient group 210 will differ depending on the embodiment implemented. For example, in some Q&A systems, all previously-registered members may be notified of any new questions by other members, in which case all such members may be within recipient group 210. In other embodiments, recipient group 210 may be comprised of individuals who have subscribed to a forum, subscribed to a thread, “followed” asker 200, or been asked to answer the question by asker 200 or other users. Recipients can be asked to answer a question when a user, such as the asker, specifies the recipient for notification of the question, such as by entering the recipient's contact address manually, selecting the recipient from a user-specific address book, selecting the user via a search function, or the like. External participants 220 are users other than recipient group, who come upon a question via means other than notification, such as search or browsing within a web site. It is contemplated and understood that some embodiments of the concepts described herein could be implemented with all users within recipient group 210, and with no external participants 220. In other embodiments, all users other than asker 200 may be external participants 220, with no option to provide push notification to a recipient group 210.

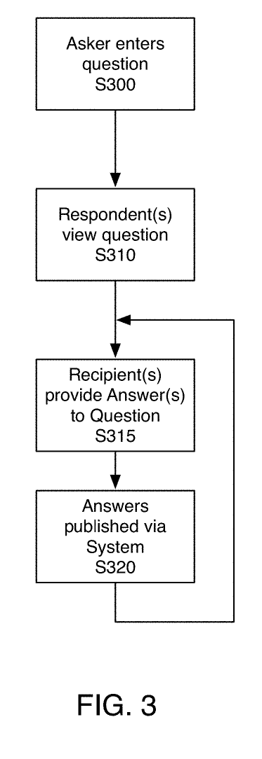

FIG. 3 is a flowchart illustrating an exemplary process by which the individuals depicted in FIG. 2 utilize the communications system of FIG. 1. In step S300, asker 200 communicates a question to servers 100 via network 110. The question can be conveyed via any of several communication methods, including, without limitation: entry into a web page rendered in web browser software on a device such as PC 120, tablet 122 or smartphone 124 in communication with web server 106; entry into a mobile app installed locally on tablet 122 or smartphone 124 and communicating with server 100; or transmission via SMS or MMS messaging from smart phone 124 to messaging server 108. It is contemplated and understood that different embodiments may utilize one or more such mechanisms for conveying questions, in varying combinations, depending upon the desired characteristics of the system implemented.

In step S310, users (including potential respondents) view the question, such as via a web browser executed on one of user devices 120, 122 or 124, communicating with servers 100. In step S315, one or more users from amongst users 210 and 220 submit answers to the question.

The term “answer” is used herein to refer to communications responsive to an initial “question” communication. It is contemplated and understood that the term “answers” may include any type of communication responsive to a “question.” Further, it is contemplated and understood that the term “question” may include any number of types of opening communications intended to lead to an exchange of thoughts or opinions between multiple users. For example, a “question” could include a request for clarification or additional information by the asker, or an invitation to comment on a document, news article or other topic. In this way, communication system embodiments described herein can be utilized broadly as dialog engines, facilitating the exchange of communications, such as ideas or opinions on a particular issue, between two or more people. The asker can also be referred to more broadly as an opening user, to the extent that the asker's communication opens the dialog with other users.

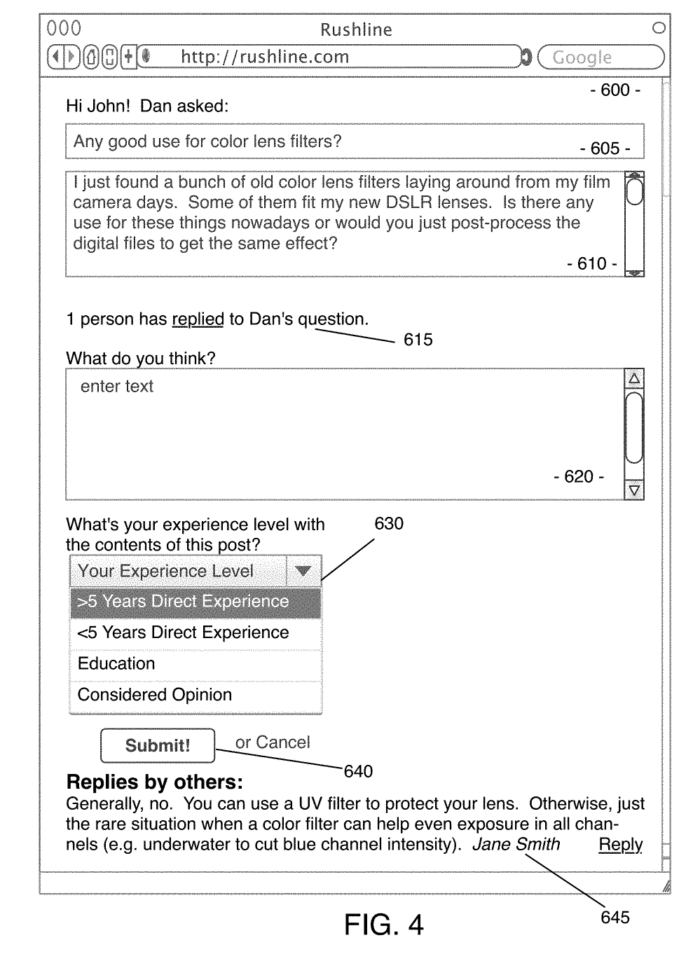

One or more means of communication can be utilized to submit an answer in step S315. FIG. 4 illustrates an exemplary user interface for submission of an answer by a one of users 210 or 220. Web page 600 is rendered on a user device via communication between the user device and web server 106 implemented within server 100, in response to selection of a Reply user interface element associated with a question viewed in step S310. Fields 605 and 610 state the question to which a response is being provided. Field 615 notifies the user of the number of replies to date, and provides a link to view those replies, which are also displayed lower on the page in region 645. Text entry field 620 enables a user to enter their response. Field 630 enables entry of a post-level qualifier, explained further below. When the user has finished entering an answer into field 620, selection of button 640 advances the process of FIG. 3 to step S320.

In step S320, answers provided in step S315 are published. Preferably, the publication in step S320 includes making the answer content available via request to networked database 104. Making answer content available via request to a networked database 104 can be achieved in a number of ways, some or all of which may be provided simultaneously. One such way is via an Internet web site implemented by web server 106, communicating with database 104. Another means of making answer content available is via request from a locally-installed application executed on user device 120 and interacting with networked database 104, potentially through an API or application server within server 100. Another is via request from a mobile device application executed locally on user devices 122 and 124 and interacting with networked database 104, again likely through an API or application server within server 100.

Optionally, asker 200, recipients 202 and external participants 220 can be configured to receive direct communication of answers. For example, asker 200 may receive a direct message via a predetermined form of communication (e.g. email, SMS, app notification), immediately upon receipt of an answer by server 100 in step S315. Server 100 can also be configured to promptly transmit digital communications containing content from an answer communication of step S315, to one or more members of recipient group 210. Notifications can be triggered by criteria which may include post-level qualifications, discussed further below.

One particular challenge in implementation of an effective Q&A system is qualifying the source of information provided, often as a proxy for answer quality. Some existing systems utilize mechanisms such as comprehensive profile building where a person's skills or relevant experiences are either entered directly by users themselves or by other members of the community that know and can “vouch” for them. Another commonly used mechanism is a voting system whereby, for example, the more votes a message receives by other users, the higher it appears in the thread. Another exemplary mechanism for qualifying answers is a point system, whereby, e.g., the more points an answerer has (either through their historical participation or through some algorithmic determination made by a system from any combination of input sources and weightings), the more weight their answer is given. Community participants typically see all posts within a thread, although they may be sequenced in descending order of votes or points. However, votes or points may not necessarily correlate to the quality or accuracy of information provided. This can be particularly the case with opinionated topics, such as politics, where answer quality often degrades when strangers with polarized beliefs begin participating. Also, particularly for communities involving discussion of diverse subject matter, global user qualifiers such as point and reputation based scoring systems can fail to capture different levels of knowledge and expertise in different subject matter. For example, a medical doctor may be highly qualified to provide accurate answers to questions about human anatomy; yet that same individual may be far less qualified to provide reliable and detailed answers to a question about photography.

In accordance with some embodiments of the systems described herein, post-level predefined qualifiers are utilized as a proxy for, amongst other things, insight into a publisher's qualifications, background or viewpoint as it relates to the specific contents of one of their posts. A post level qualifier can provide a statement indicative of the contributor's personal level of qualification to answer the question or otherwise provide the contributed content. Post level qualifiers may describe, for example, the type or level of a contributor's previous personal experiences relative to the contributed subject matter, the type or level of a contributor's knowledge of the subject matter, or the level of the respondent's confidence in their answer. One or more qualifiers can be required for each post, whereby participants select from various predetermined, delineated qualifiers, enabling a new, natural way to instill quality into posts and into a subsequent reader's user experience.

In some embodiments, certain post-level qualifiers may be automatically required for every answer as a system constraint. In other embodiments, post-level qualifiers may be required, optional or turned off for each post, at the discretion of the asker or the system administrator.

One example of a post-level qualifier that may be advantageous is an experience level qualifier. Preferably, an experience level qualifier will be included as a mandatory component of answers provided to the system. For example, a system implementation may require that all responses include a selection from a fixed, delineated set of qualifiers that best describes the respondent's knowledge or experience level with the specific contents of the opening content or their reply.

Implementations of a post level qualifier, and particularly an experience level qualifier, can provide several key values to the system and its participants. For example, the self-reported nature of the post level qualifier election can be important because often only the person posting knows their level of qualification to answer, or their first hand experience with the content they have entered. Also, an objective, delimited measurement of qualification level can be valuable because (a) it allows future readers to easily compare experience levels of various posts when qualifiers are selected from amongst a common set of criteria; and (b) it provides a meaningful, systematic way to use that data as a filter during future recall and/or presentation of content. Implementing a rating that is for the specific content entered can be important because the contributor's experience level with detailed matters often cannot be accurately depicted at a meta-biographical-data level.

Further, affixing an author's qualification or experience level rating at the point in time a post was made can be useful to the extent that contributed content persists over time. For example, two years after making a post, a person's biographical information might indicate they have three years experience on the topic of the post, while when the post was originally made, they only had one year of experience. In certain embodiments described herein, if an author indicates they have one year of experience when a post is made, five years later someone reading that post will still see that the post was made based on one year experience.

Such an objective, delimited, consistent, self reported, point in time rating may have secondary benefits in addition to providing an easy way to compare and assess content. Specifically, it may encourage people to feel comfortable posting and participating by excluding many of the negative side effects of existing systems outlined above. They may even prefer the opportunity to “disclaim” their posts as being opinion or based on limited knowledge, much the same way they would in natural conversation, but in this case using an objective, consistent measurement in the form of a delimited list of experience criteria.

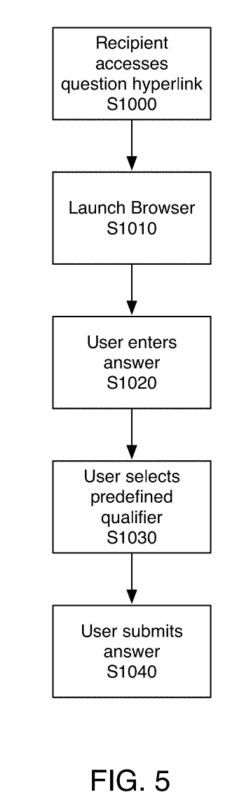

FIG. 5 illustrates an exemplary embodiment of an answering subprocess corresponding to step S315 in FIG. 3, in which an answer includes an experience level qualifier. In step S1000, the user accesses a hyperlink provided in the question notification of step S310 using a network-connected electronic device, such as user devices 120, 122 or 124. The user's device launches a web browser application resident on the user device (step S1010), which communicates with server 100 to render web page 600 facilitating entry of a response (FIG. 4). In step S1020, the user enters a response in text field 620. In step S1030, the user specifies from a group of predefined qualifiers. In the embodiment of FIG. 4, the experience qualifier is selected via drop down menu 630 having predetermined choices including: greater than 5 years of direct experience, less than 5 years of direct experience, education, or considered opinion/no experience. In step S1040, the user selects user interface element 640 to submit the answer to server 100. The experience qualifier selection in menu 630 is stored in database 104 in conjunction with the answer content in field 620, amongst other data.

It addition to requiring respondents to select from amongst a predefined set of qualifiers that best describe the respondent's knowledge or experience level, some embodiments may also require the opening user to specify his or her own experience level qualifier associated with the opening dialog content. This can be accomplished via, e.g., presentation to asker 200 of a user interface element comparable to pick list 630 in FIG. 4 during entry of a question in step S300.

The knowledge or experience post-level qualifier can subsequently be used by viewers of the post to interpret the accuracy or weight to be given to the post. Preferably, the post-level qualifier provides a granular application of author experience level as it relates to the specific content posted about, rather than the general topic of the entire thread. Even within a given dialog, a user may have differing qualifications. For example, a medical doctor may have direct experience performing a surgical operation in one way, but only informed opinion regarding an alternative way of performing the operation. Post-level predefined qualifiers can enable the doctor to contribute from both perspectives within the same dialog, while providing content consumers with accurate context for each response.

In addition to providing granular context and insight for content consumers, the experience qualifier can also be used to filter messages. For example, for a question with a large volume of responses, a user may filter to view only answers from individuals having a certain level of direct experience in the matters discussed. Similarly, when viewing search results or a personalized feed of followed questions, experience level can be used to limit the posts that appear in such results.

By itself, viewing and filtering using experience or knowledge qualifiers may be helpful at addressing quality issues. However, in conventional online communities, individuals may be inclined to inflate or otherwise misrepresent their experience level with a particular answer. This problem can be mitigated by implementing post-level qualifiers within a real-name environment, in which a respondent's real name, identity or contact information is visible to some or all other users, thereby providing some level of accountability. When combined with such a system, the experience level qualifier can become extraordinarily meaningful to future viewers of the dialog.

In some embodiments, askers will have the option of applying custom, post-level qualifiers to a question, typically requiring that respondents include information responsive to the custom post-level qualifier when answering. In conventional Q&A communities lacking post-level qualifiers, questions can result in contextually flat answers, where the system treats each answer as if it came from the same perspective. As a result, readers may have to interpret the context and background of the answerer relative to a specific question in order to assign credibility to that answer. For instance, a post about a decision made by a democratic president is likely to be assigned different value when made by a democrat than when made by a republican. Similarly, an answer about a fashion trend might be viewed differently if an observer knew that the answer came from a teenager versus a middle-aged adult. While neither respondent's answer may be right or wrong, inability to perceive the respondent's perspective in answering may lead an observer to a general perception of low quality or low value content. In other cases, dialog between individuals with fundamentally differing backgrounds and perspectives may devolve into heated arguments, particularly for opinion-based dialog, chasing away any higher quality responders and degrading or sidetracking whatever dialog does occur.

Some online communities may attempt to address these challenges by aggregating a community of members sharing similar backgrounds. However, this approach inherently limits the size and diversity of the community, inhibiting the ability to implement a Q&A system with broad subject matter diversity and user base. Another approach made by some online communities is to accumulate user-based biographic information in association with a user's profile in order to provide some level of insight into a respondent's background. However, it may be impractical to pre-emptively collect and present enough relevant biographic information in a system having wide diversity of subject matter.

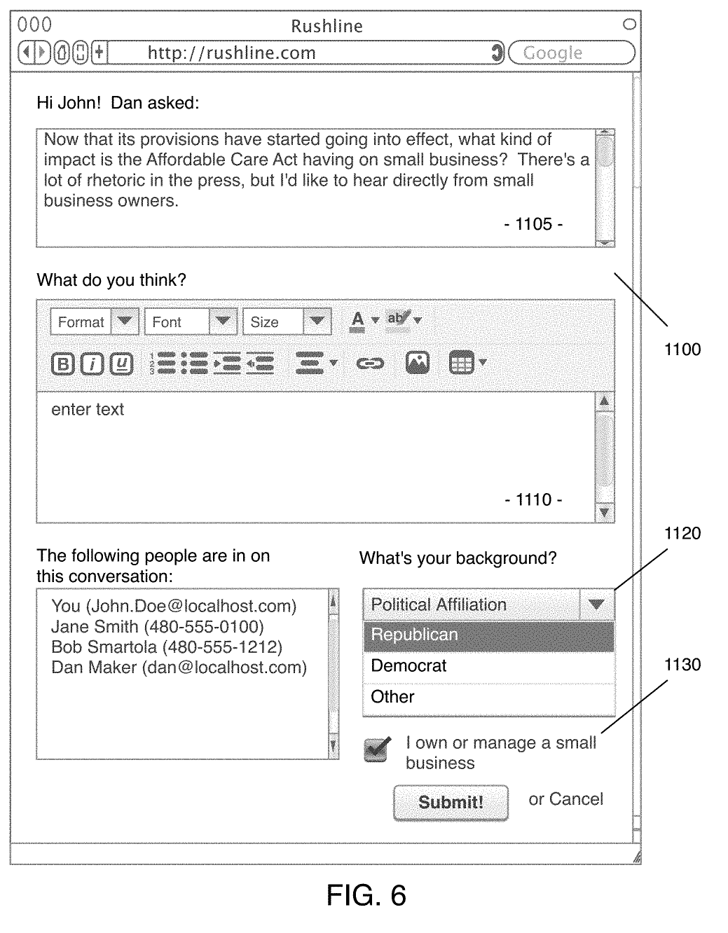

Post-level custom qualifiers allow a question originator to require respondents to input one or more elements of information, at the time the answer is provided, that may provide context to the originator and/or other readers of the answer. FIG. 6 illustrates a user interface rendered in a web page 800 on a user device for answering a question for which post-level custom qualifiers have been configured. Answer box 1110 is provided for input by a user of a response to question 1105. Question 1105 was configured by the asker with two custom post-level qualifiers, represented by user interface elements 1120 and 1130. Qualifier 1120 is a pull-down menu for political affiliation allowing a selection from amongst three options: Republican, Democrat and Other. Qualifier 1130 is a checkbox enabling a respondent to identify themselves as an owner or manager of a small business.

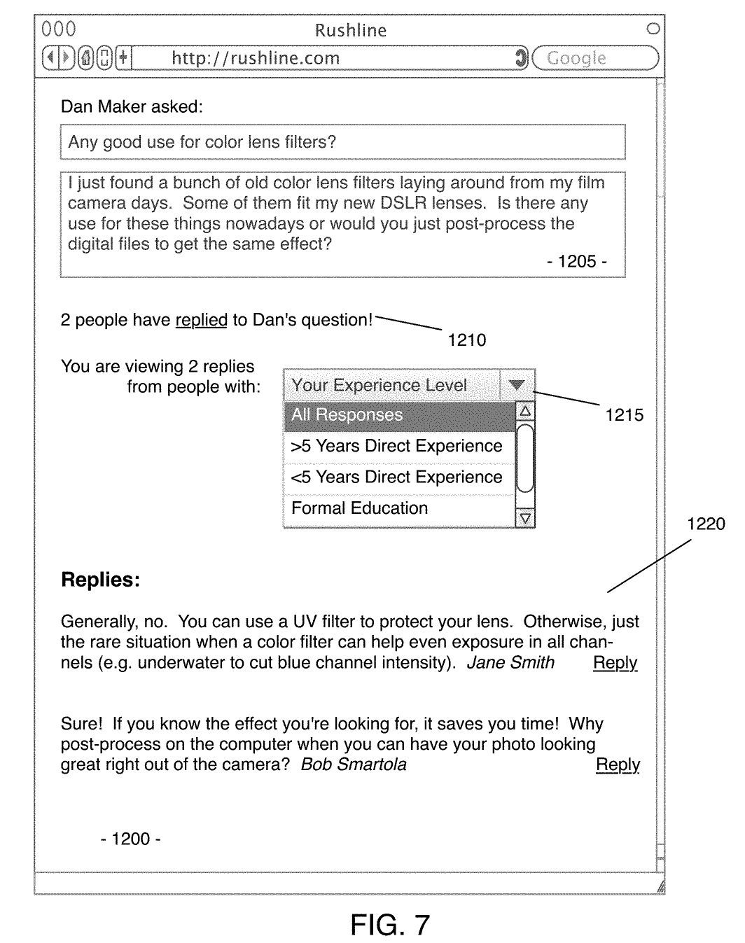

When dialog content is viewed by others, experience post-level qualifiers and custom post-level qualifiers can be used to filter and organize that content. For example, FIG. 7 illustrates a view provided to external participants 220 of responses to the question submitted in FIG. 4. Web page 1200 includes a recitation of the question 1205 and a statement 1210 of the total number of replies available for viewing. Pulldown menu 1215 enables the viewer to select a minimum post-level qualifier in order for a response to be rendered in the user's view. Region 1220 provides a rendering of responses satisfying the minimum experience qualifier set using pulldown menu 1215. Using the system of FIG. 7, a user can dynamically adjust the minimum threshold experience-level qualifier and focus in on answers with the desired level of experience-based credibility.

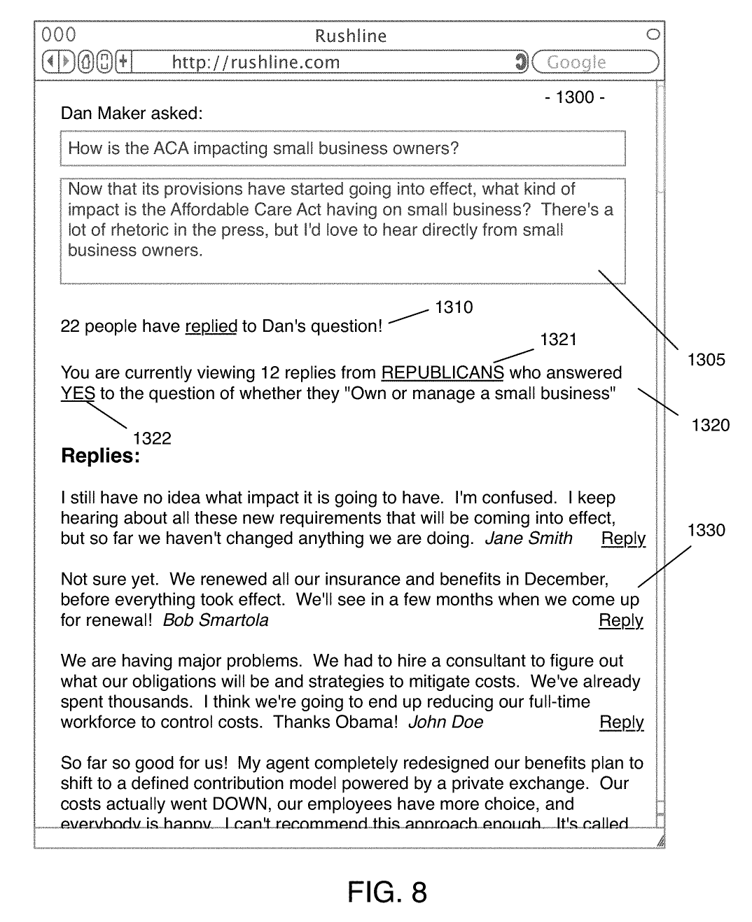

FIG. 8 illustrates another user interface embodiment enabling a viewer to filter responses to the question submitted in FIG. 6, which question includes custom post-level qualifiers. Web page 1300 is rendered on one of user devices 120, 122 or 124 via query to server 100 via network 110, and retrieval of question and answer information from network-connected database 106. Web page 1300 includes a recitation of the question 1305 and a statement 1310 of the total number of replies available for viewing. Interactive filter 1320 includes a recitation of the current custom qualifier filter criteria, along with hyperlinked criteria specification elements 1321 and 1322 which enable a user to interactively adjust the filters applied. Filter element 1321 limits the displayed responses based on the respondent's selection in qualifier field 1120 of FIG. 6. Selection of filter element 1321 provides further options for the viewer to select filter criteria from amongst any option of qualifier 1120 (Republican, Democrat, Other) or an all-inclusive “Any” option. Filter element 1322 limits the displayed responses based on the respondent's selection in qualifier field 1130. Selection of filter element 1322 provides further options for the viewer to select filter criteria from amongst the potential designations in qualifier 1130 (i.e. YES or NO). Region 1330 displays dialog content responsive to the criteria specified in filter 1320. Using these mechanisms, users can quickly identify content most relevant to them. To the extent a user seeks to narrow results to those having the highest value and reliability, the user can utilize the filter criteria as inherent indicia of reliability.

Another challenge with Q&A systems is enabling users to find content most of value to them, within a potentially enormous collection of content, while avoiding the presentation of content that a reader would find to be of poor quality or irrelevant. Embodiments described herein leverage some of their unique features to implement a “zoom” feature. The Q&A or dialog zoom feature can significantly enhance the value of the user experience by allowing a user to interactively control the scope of information presented to them, including potentially exposing them to dialogs from people they don't know but who meet certain qualifiers they have set. In this way, the viewing user can selectively limit what posts they see based on the objective, systematic experience or knowledge level of the poster relative to each post, for instance 2-5 years experience. This filter can be applied to a list of search results, showing only results where the chosen qualifying threshold is met, or within an individual thread, thus screening out replies that don't meet the threshold criteria.

Alternatively, this filter can be set as the user's default such that they always only see content meeting that criteria throughout their use of the service unless they manually “zoom out” to see content of a lower experience rating or change their default. This can improve the signal to noise ratio considerably. For a regular user, being able to filter their view by experience level may present a new type of community experience of a much higher signal to noise ratio. At the same time, providing ready ability to dynamically expand a user's view when a broader cross-section of content is desired preserves the system as a comprehensive source of information. To the extent the zoom filter is based on objective and consistent criteria, it presents a unique way to see the content of most value while avoiding content of lower value, therefore avoiding user frustration and increasing the value they receive for the time they spend using the service.

The zoom filter feature may be enabled via a slider control, making it easy for a user to broaden or restrict their view. Further, in some examples, it may allow the user to restrict their view only to the posts of the original members of the conversation.

Other embodiments of content zoom may utilize other inputs in addition to or in lieu of experience level qualifiers, such as the degree of social network relationship connection between the viewer and content contributors. For instance, if a content contributor is an accepted contact associated with a viewer, that contributor's posts may show up even when a viewer is zoomed in to a very restrictive view. As the viewer zooms out, content from the contacts of the viewer's contacts (i.e. second degree connections) may be included in the view.

Another contemplated input to a relationship-based zoom is to analyze the mutual threads various users may have contributed to together. Contributors with whom a viewer has previously participated in common conversations with may show up in a narrower, restricted view. Content from people those people have participated with may show up on the next level out, and so on.

In such cases, zoom works in a systematic way to allow a user to influence the level of signal to noise they are interested in seeing. For topics with a significant amount of high value content, they may stay zoomed in to the narrowest level. When the narrowest level does not contain what they are looking for, they may zoom out successively to see if other useful information exists as the potential noise also increases.

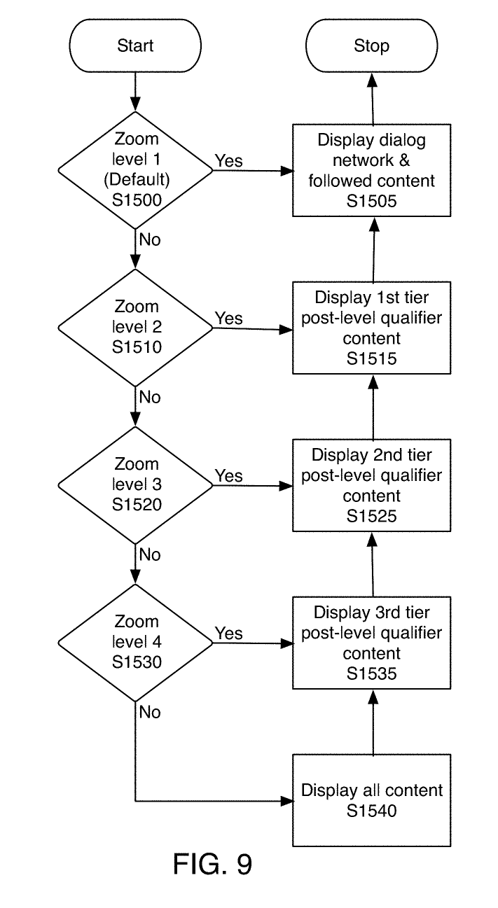

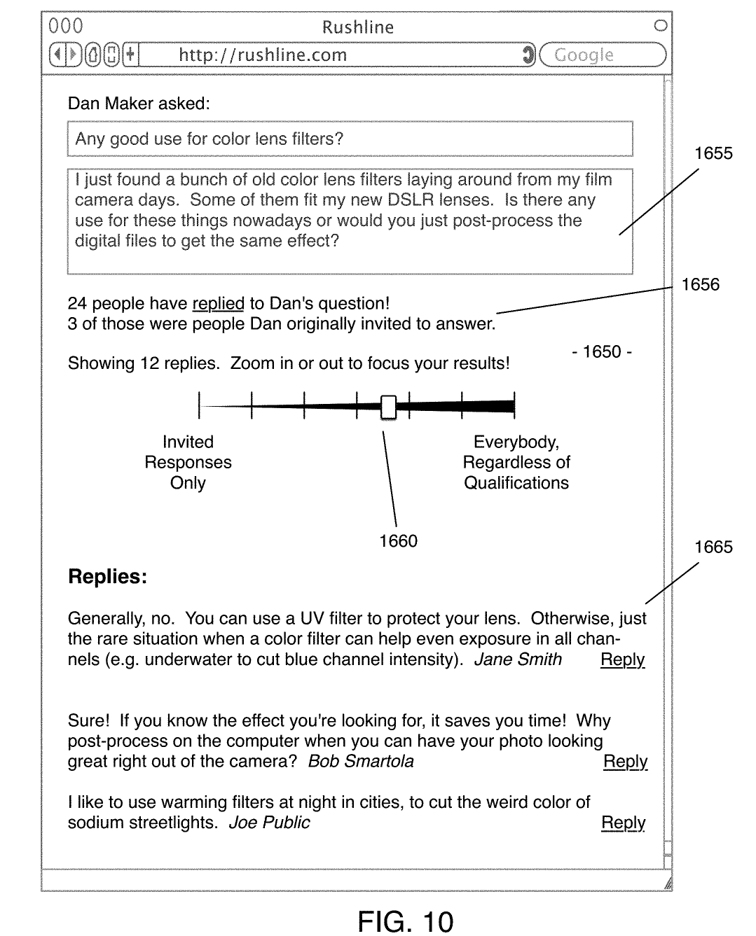

FIG. 9 illustrates an exemplary process embodiment for generating a Q&A platform user view with a content zoom feature, thereby determining content presented to the user. FIG. 10 illustrates an exemplary user interface implementing the process of FIG. 9. The embodiment of FIGS. 9 and 10 implements content zoom functionality using two view paradigms: association-based view and qualification-based view.

Association-based view control enables a user to control content displayed to them based on the content contributor's association with the other members of the dialog and/or the viewer. Different types of pre-existing associations between users can be utilized to filter content presented in an association-based view. One example of association-based view criteria is whether the content contributor was explicitly invited to participate in the discussion by the asker (i.e. dialog network membership).

Social networking relationships between users, including pre-existing relationships within third party social networking environments, can also be utilized as filter criteria in creating an association-based view of user generated content. For example, within the communication system of FIGS. 9 and 10, an association-based view can be determined by, e.g., whether the content viewer has previously created an association with the contributor for any given piece of user generated content, such as by manually “following” as particular content contributor. Other types of social network relationships that can also be utilized as filter criteria in creating an association-based view of user-generated content include, e.g., whether the viewer is “friends” on Facebook™ with the contributor of each piece of content, or whether the viewer is a First, Second or Higher degree connection on LinkedIn™ with a content contributor.

Another potential association-based view criteria includes prior dialog. Specifically, whether the viewer has previously engaged in communications with a content contributor, such as the viewer and contributor having previously submitted content to a common dialog thread. This criteria could be implemented in a number of ways, such as a binary filter (e.g. the viewer has or has not previously engaged in dialog on the system with a contributing user), or a prioritization filter (e.g. presenting content generally in descending order of the frequency with which the viewer has previously engaged in communications with a content contributor within the communication system).

Yet another type of pre-existing association that may form the basis for an association-based view criteria may be based on users' biographical information. Given a system in which users are associated with biographical profiles, profile information can be searched, and optionally compared between users, as the basis for view filter criteria. For example, a view may be limited to (or may prioritize) content from contributors having similar skills endorsements, common schools attended, common areas of study, common employers, common interests, or other relevant biographical profile associations.

In addition to association-based view control, the embodiment of FIGS. 9 and 10 also relies on qualification-based view control, using post-level qualification elections as a criterion for whether a post's content is displayed. When post-level qualifiers are selected from a predetermined ordered sequence (rather than, e.g., free-form text entry), the post-level qualifier can be used as a dynamic user-controlled criterion for filtering a user's view of dialog content as well as for configuring notifications of desired dialog content.

For example, upon identifying and selecting a dialog for viewing, a user is presented with a dialog view, such as that rendered via web page 1650. The view 1650 includes display of the question 1655, and response summary 1656 which includes the total number of responses available (i.e. the maximum number of responses available to view when “zoomed all the way out”), and the number of responses submitted by individuals within recipient group 210 (i.e. the minimum number of responses to view when “zoomed all the way in”). Slider control 1660 is provided to enable the user of web page 1650 to adjust the zoom level of displayed results.

Region 1665 displays the content of replies corresponding to the selected zoom level, i.e. the position of slider 1660. The process of FIG. 9 determines the subset of replies to question 1655 that are displayed in region 1665, based on post-level qualification. For example, in the embodiment of FIG. 4, answers are tagged with one of four levels of post-level qualification in an ordered sequence (from high to low: >5 Years Direct Experience, <5 Years Direct Experience, Formal Education and Considered Opinion). The position of zoom level slider control 1660 establishes a post-level qualifier view threshold value for display of a given answer within a user's published view. If zoom level slider control 1660 is set in its first position (i.e. “zoomed all the way in”) (step S1500), then in step S1505 region 1665 is populated with content contributed by members of the dialog network for question 1655, as well as any content explicitly “followed” by the user viewing page 1650. If zoom level slider control 1660 is set in a second position (step S1510), then content region 1665 is populated with additional content contributed by individuals beyond the original dialog network, specifically content from contributors having a top-most tier of post-level qualification (step S1515), as well as members of the original dialog network and explicitly followed content (step S1505). If zoom level slider control 1660 is set in a third position (step S1520), then content region 1665 is populated with content from contributors having a 2^{nd} tier of post-level qualification (step S1525), contributors having a 1^{st} tier of post-level qualification (step S1515) and members of the dialog network and explicitly followed content (step S1505). If zoom level slider control 1660 is set in a fourth position (step S1530), then content region 1665 is populated with content from contributors having a 3^{rd} tier of post-level qualification (step S1535), 2^{nd} tier of post-level qualification (step S1525), 1^{st} tier of post-level qualification (step S1515) and the original dialog network and explicitly followed content (step S1505). If zoom level slider control 1660 is configured beyond the fourth position (e.g. zoomed all the way out), then all content is displayed in region 1665 (step S1540).

In an exemplary embodiment, view 1650 is generated on a user device (e.g. user devices 120, 122 or 124) via communication with server 100 via network 110. Adjustment of slider control 1660 causes communication of a revised zoom level (i.e. revised view threshold level) to server 100, and particularly web server 106, and query of network-connected database 104 for dialog content associated with corresponding experience-level and/or custom qualifiers. The corresponding dialog content is then returned to the user device for display to the user. Similarly, it is contemplated and understood that alternative techniques for carrying out the above-described content zoom functionality could be readily implemented. For example, the entirety of dialog content could be transmitted to and stored within the user device upon initial query or loading of view 1650, at which point filtering of results can be executed locally on the user device, with the appropriate subset of content displayed within region 1665 based on a hierarchical relationship of content metadata (such as ordered sequences based on qualification level, custom qualifiers and association groups) relative to a view threshold level. Such an embodiment may carry greater data transmission overhead initially, but result in more responsive display updating upon adjustment of slider 1660 by the user.

FIGS. 9 and 10 illustrate an exemplary embodiment of content zoom functionality using content display criteria dependent on selection from amongst a plurality of mutually-exclusive post-level qualification elections, a contributor's invitee status within a question recipient group, and “follow” mechanisms through which a user can flag content from another user to “follow”, thereby promoting that content into the subset visible to the following user. However, it is expressly contemplated and understood that other variations of the illustrated content zoom functionality, process and system could readily and beneficially be implemented. For example, it may be desirable to create views with an even “higher level of zoom” by applying post-level qualification requirements even to contributions from members of a question recipient group or members “followed” by the viewer, such that low-qualification content can be excluded even if the contributor was followed by the viewer or expressly invited by the original asker. Alternatively, different zoom levels could be created using different or additional post-level qualifications. Different zoom levels could also be created using other criteria, such as contributor-level characteristics (e.g. contributor scores, peer ratings or activity levels) or contribution content analytics, in combination with post-level qualifications or otherwise. Qualifier-based filters and association-based filters could be separated out to different user interface elements, such as a slider to control a threshold level for a given qualifier setting while utilizing a toggle switch to alternatively show and hide content having a particular association-based criteria, such as whether the contributor is a member of the dialog network or external participant. These and other variations can be readily implemented in accordance with the teachings herein.

In addition to using qualifiers, such as association and post-level qualification, as criteria for dynamically controlling the scope of content presentation, qualifier-based views of Q&A system content can also be utilized in an online electronic communication system to implement simultaneous overlapping dialog streams.

Conventional Q&A systems or message forums allow users to start numerous message threads. The message threads may be organized by topic or other means to help a user identify desired content, but typically once a thread is viewed, the viewer sees the entire thread. In some prior systems, responses may be ordered by voting or other scoring mechanisms to prioritize some answers over others, with low-ranked answers possibly hidden behind an additional hyperlink. But functionally, each conventional thread typically acts as a single discussion with each contribution a part of the discussion, and the threads operate independently from one another with each post available in only one thread.

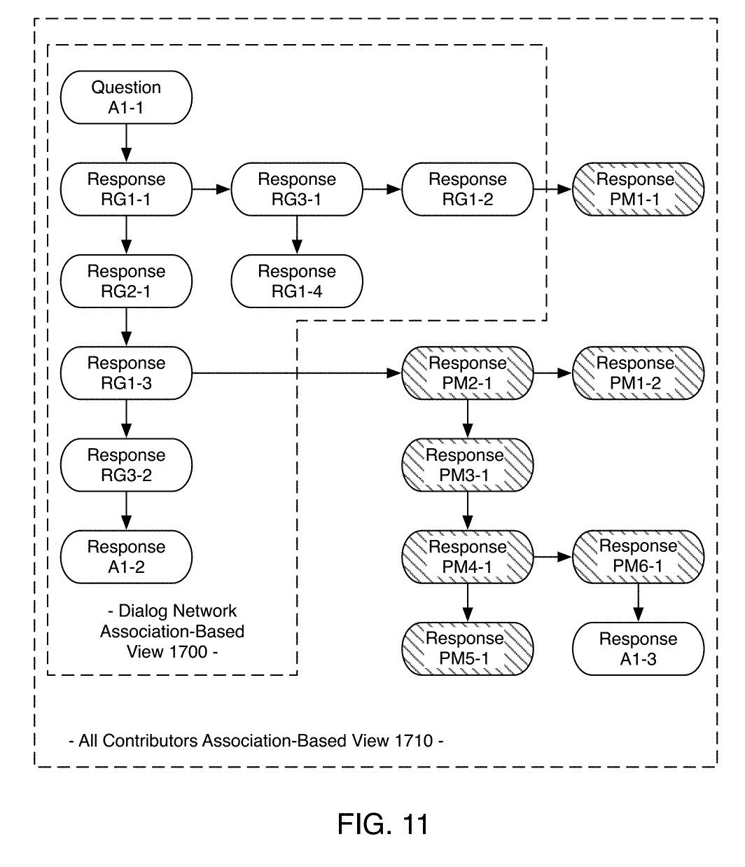

By contrast, association-based views can enable content contribution to be multi-purposed into parallel levels of discussion. For example, FIG. 11 illustrates a discussion thread amongst question asker A1; recipient group members RG1, RG2 and RG3; and public user members PM1, PM2, PM3, PM4, PM5 and PM6. Posts (i.e. content contributions) are illustrated in the dialog diagram of FIG. 11 by a contributor reference, followed by a contribution reference numeral. Thus, recipient group member RG1 is responsible for three posts in the example of FIG. 11: RG1-1, RG1-2 and RG1-3.

By default, members of the dialog network (A1, RG1, RG2 and RG3) are configured for dialog network association-based view 1700. In view 1700, dialog network members are notified of each post that is made by individuals within the dialog network: Question A1-1, and Responses RG1-1, RG3-1, RG1-2, RG1-4, RG2-1, RG1-3, RG3-2, and A1-2. Further, when viewing the dialog on the platform, they have a default association-based view that includes only content contributed by the dialog network members. Therefore, to the asker and recipient group members, the dialog of FIG. 11 seems to be a private dialog, without interruption by untrusted strangers, spammers, inflammatory posters or low-quality contributors.

Simultaneously, other system users may participate in the dialog of FIG. 11 with a different association-based view, thereby gaining value and insight from the dialog network discussion. In the exemplary embodiment, public members PM1 through PM6 are configured by default with an “all contributors” association-based view 1710, for which the view level threshold includes all dialog content, regardless of the contributor's association to the dialog or viewer. Thus, public member PM2 is able to respond to RG1-3 by submitting PM2-1. Response PM2-1 is then available for review, and optionally response, by others having an inclusive view. Therefore, PM1 and PM3 can each respond to PM2-1 via contributions PM1-2 and PM3-1, respectively. However, these uninvited responses are not visible to dialog network members A1, RG1, RG2 and RG3 in default view 1700, thereby preventing uninvited contributions from PM1, PM2 and PM3 from detracting from the conversation amongst the dialog network members. This implementation of association-based views allows dialog network members to engage in what feels like a private conversation amongst themselves within view 1700, while enabling the broader public to benefit from that same content, and participate in the context of a public discussion, within view 1710.

Optionally, dialog network members can choose to expand their view by modifying their view level threshold, zooming out to a more inclusive association-based view of the dialog. This may be desirable when, for example, a dialog network member desires to seek out more content from a broader audience, such as if they are not satisfied with the content contributed within the dialog network or if the topic is of particular interest such that more time is dedicated to it. Rather than having to reproduce the query in a different forum, such as one with broader or different membership, a user need only adjust their association-based view to immediately gain the benefit of a broader community. In the example of FIG. 11, asker A1 has expanded to All Contributors view 1710, such that A1 was able to view public member response PM6-1 and respond to that content with Response A1-3. Expansion of a user's view may optionally also include expansion of content contributions that are conveyed to a user via notifications. Thus asker A1 may elect to receive push notifications of content from all respondents, rather than only dialog network members.

While the embodiment of FIG. 11 contemplates providing association-based view 1700 by default for all dialog network members (including the asker), it is contemplated that other embodiments may alternatively default the asker to the All Contributors association-based view 1710. By providing an asker with view 1710 by default, the asker can receive the benefit of a response made by an external user that is of particularly high value, and potentially have the option to make other dialog network members aware of the valuable external contribution in the event that they have not elected to manually expand their view to see what else has been posted by people other than dialog network members.

The above-described association-based views can readily be implemented using the systems and processes described elsewhere herein. For example, Responses RG1-1 and the like can be solicited via communications between server 100 and user devices 120, 122 and 124, as described in connection with, e.g., FIGS. 4, 6 and 7. Views 1700 and 1710 can be generated via communications between server 100 and user devices 120, 122 and 124 similarly to the operations described in connection with, e.g., FIGS. 8 and 10.

In addition to the FIG. 11 example of enabling parallel public/private discussions based on user association with a dialog network, other types of associations can be utilized to maintain parallel and related subdialogs depending from a parent dialog, which can also be referred to as parallel inherited conversations. In many real-world situations, conversations generate their own sub-conversations. One example of this is speaker events. One or more people may be presenting or having a conversation on stage while groups of people sit at tables watching, sometimes breaking out into their own conversations about what they are hearing. Another example are national political debates, where a group of candidates engage in a dialog, and subgroups including local level political representatives provide their thoughts or feedback on those conversations as they happen or shortly thereafter.

Existing online systems tend to be too linear and simplified to handle such conversations. Many intentionally focused on remaining simple because simplicity encouraged mass audiences to participate. One example is Twitter™, where 140 character posts are provided in a generally unstructured environment. Other sites, such as those powered by or modeled similarly to common forum software, introduce reply threading, whereby someone may participate at the top level thread, or in a nested conversation that is a reply to one of the earlier replies rather than to the top level topic itself. Such a hierarchical reply structure may help a reader understand the content to which a specific post is responding, but does little to organize large group discourse around complex subject matter.

By contrast, association-based views can also enable content to be organized into parallel inherited conversations. Such parallel inherited conversations can effectively and simply organize conversations that are hierarchical in nature, thereby encouraging greater discussion amongst larger groups of people and concerning more complex subject matter.

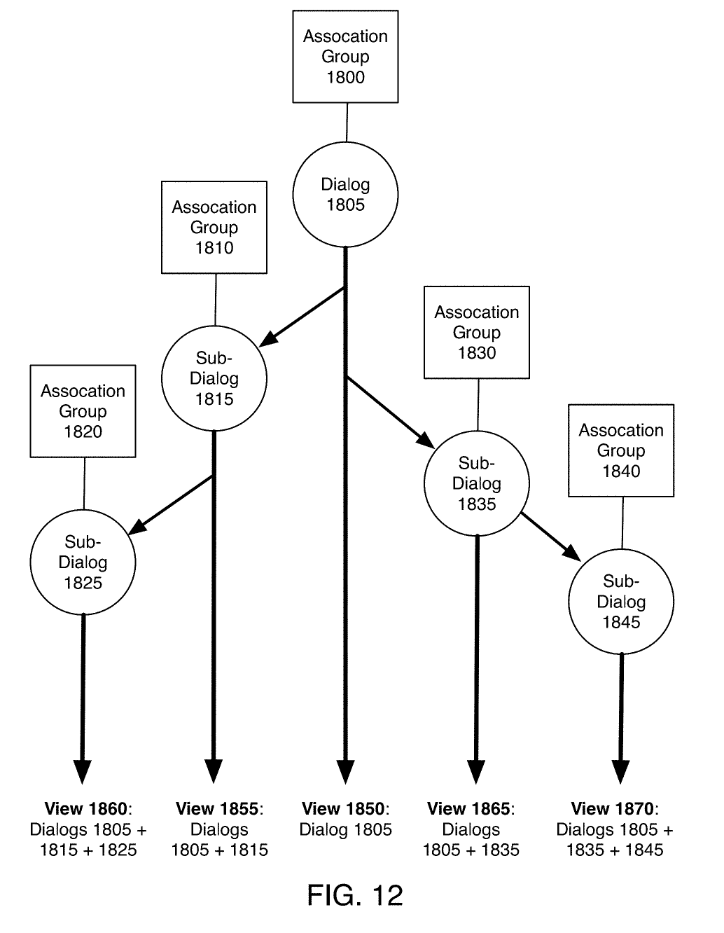

FIG. 12 illustrates an exemplary implementation using four association groups engaging in overlapping dialogs with hierarchical relationships. Users can view content associated with a subset of the association groups, where the subset can be dynamically controlled by the user. A master association group 1800 contributes content to dialog 1805, and has default association-based view 1850, which includes the content of dialog 1805. A second association group 1810 contributes content to Sub-Dialog 1815, which is subordinate to master Dialog 1805. Therefore, the default view for association group 1810 includes the content of dialogs 1805 and 1815. Association group 1820 contributes content to sub-dialog 1825, which is subordinate to sub-dialog 1815. The default view 1860 for association group 1820 includes the content of dialogs 1805, 1815 and 1825.

Preferably, any given dialog level may include multiple subordinate dialogs. For instance, in the example of FIG. 12, association group 1830 contributes to sub-dialog 1835. Sub-dialogs 1835 and 1815 are both directly subordinate to master dialog 1805. Participants in association group 1830 have default association-based view 1865, which includes the content of dialogs 1805 and 1835. Association group 1840 contributes to sub-dialog 1845, and enjoys view 1870 containing content from dialogs 1805, 1835 and 1845.

There are a number of potential use-cases in which the above-described implementation of association-based views may be highly valuable. For example, the implementation of FIG. 12 could be utilized to facilitate online communication in the context of a political debate. In such an example, association group 1800 may include a moderator and presidential candidates engaging in a debate in anticipation of national elections. The candidates and moderator can communicate back and forth in dialog 1805. By implementing view 1850, the candidates and moderator are able to focus on interactions amongst themselves. Simultaneously, association group 1810 may include members of a political organization, such as the Arizona Delegation of the Republican or Democratic Party. Arizona members can discuss the contents of candidate dialog 1805 within their own sub-dialog 1815; having view 1855, such that they see the candidate dialog and dialog from other members of the Arizona organization. Association group 1820 may be comprised of members of a Party delegation from Maricopa County, Arizona. Group 1820 communications within sub-dialog 1825, subordinate to both the Arizona Delegation dialog 1815 and the National dialog 1805. Group 1820 is provided with default view 1860, which includes the contents of dialogs 1805, 1815 and 1825. Meanwhile, association group 1830 may include members of a Utah organization of a political party. The Utah organization may be interested in having their own conversation about the candidates, without disruption or diversion by Arizona party members. Therefore, association group 1830 participates in sub-dialog 1835, which is directly subordinate to master dialog 1805. Group 1830's default view is view 1865, which includes only the contents of dialogs 1805 and 1835.

The above-described invitation-based Q&A platform with association-based views provides significant flexibility in structuring communication networks that can be dynamically configured by users. For example, in the above-described political debate example, an individual user in Utah may wish to use the platform to discuss the debate issues with a group of friends and neighbors. Such a user can dynamically initiate their own sub-dialog 1845 and invite a self-selected recipient group to be members of association group 1840. Those invitees may then engage in their own discussion of the issues within sub-dialog 1845, while enjoying a view 1870 which includes their own sub-dialog 1845, as well as contributions from the candidates in dialog 1805, and from their state's delegation in sub-dialog 1835.

Viewers of and contributors to dialog 1805 and subdialogs 1815, 1825, 1835 and 1845 may still be provided with systems, functionality and user interface components described elsewhere herein in connection with other embodiments. For example, custom qualifiers could be utilized to provide insight into contributor perspectives and/or allow users to filter content within their view. Thus, the political affiliation custom qualifier 1120 (FIG. 6) could be utilized in connection with the dialogs of FIG. 12, enabling people to alternatively focus attention on viewpoints and commentary from people who share their political views, or people who hold differing views.

Through the above-described implementation of hierarchical association-based views, individuals with divergent interests are able to utilize a common platform and mechanism to engage in meaningful interaction with a tailored participant group, while simultaneously enabling broad dissemination of communications.

In accordance with another aspect of the embodiments described herein, it may be desirable to provide enhanced notification features to help link users with ongoing dialogs that may be of value to them, and in turn, encouraging qualified users to participate with their own answers. Notification features encourage user participation in an online community by proactively alerting people to new conversations that may be of interest, rather than relying on a user returning to a site or service in a timely manner and seeking out content of interest. Existing systems may enable notification based on factors such as topical activity (i.e. alerting to all content contributions relating to a particular subject matter of interest) or social network based notifications (i.e. alerting to activity by individuals with which a user has a pre-identified relationship). However, such mechanisms may not be particularly effective in providing notifications about conversations of interest from strangers. Social network based notifications are typically narrow in scope—they are inherently limited to activity by people having a pre-existing relationship. Topical notifications can, in many instances, be overly broad. Even if a topic is narrowly defined for notification purposes, notifications may include a high proportion of “noise”, i.e. notifications about content that is still undesirable to the user due to low quality content or lack of trust in the contributor. When the proportion of notifications of content perceived to have high value drops too low relative to the overall notification volume, users tend to either turn off notifications altogether or reduce their level of engagement with them.

In contrast, dialog linking embodiments can be effectively implemented through modifying the concept of push notifications to incorporate or rely on other features described herein. Aspects of the online forum systems and methods described herein enable the implementation of highly-effective notifications that may encourage interactions between individuals not previously known to one another. People can feel like they are simply participating in a messaging system with their known colleagues, yet easily and carefully choose to be notified when posts are made on topics important to them, from others who a user considers to be qualified to comment. This allows people to explore and open themselves up to being notified of posts from strangers, without the high levels of “noise” from unqualified and low quality posts that can occur in traditional Q&A sites. People can therefore be introduced to people and posts of high interest to them beyond their own personal contact groups.

In an exemplary embodiment, by allowing a user to input substantive content criteria such as a search term, presumably a word or phrase in which they are highly interested at a particular time, combined with criteria such as an experience level qualifier or zoom level setting, the user can be notified when posts very likely to be of high value to them occur. For example, a surgeon contemplating performing a new or unusual procedure such as “artificial lumbar disc replacement” can configure push notifications by entering that search term along with an experience criteria, such as 5+ years experience, such that the surgeon is notified when posts very likely to be of very high value to them occur. Since this is presumably a relatively new or rare medical procedure that a limited number of surgeons perform, the few posts that do occur, especially among highly experienced people with 5+ years experience, would likely be of extraordinary value to the person configuring this dialog linking notification. This in turn creates significant motivation for the user to respond to those notifications while the conversations are still going on, greatly increasing the chances that they may choose to participate as well.

In a system incorporating such dialog linking push notifications, people are likely to be introduced to others of the most similar knowledge backgrounds on the topics they care most about, and critically important, at the right time when they themselves can participate because the conversations are still ongoing. In an otherwise already functioning community, this dialog linker may present one of the most practical and successful means of capturing the profound possibility of wide scale problem solving and knowledge discovery among strangers.

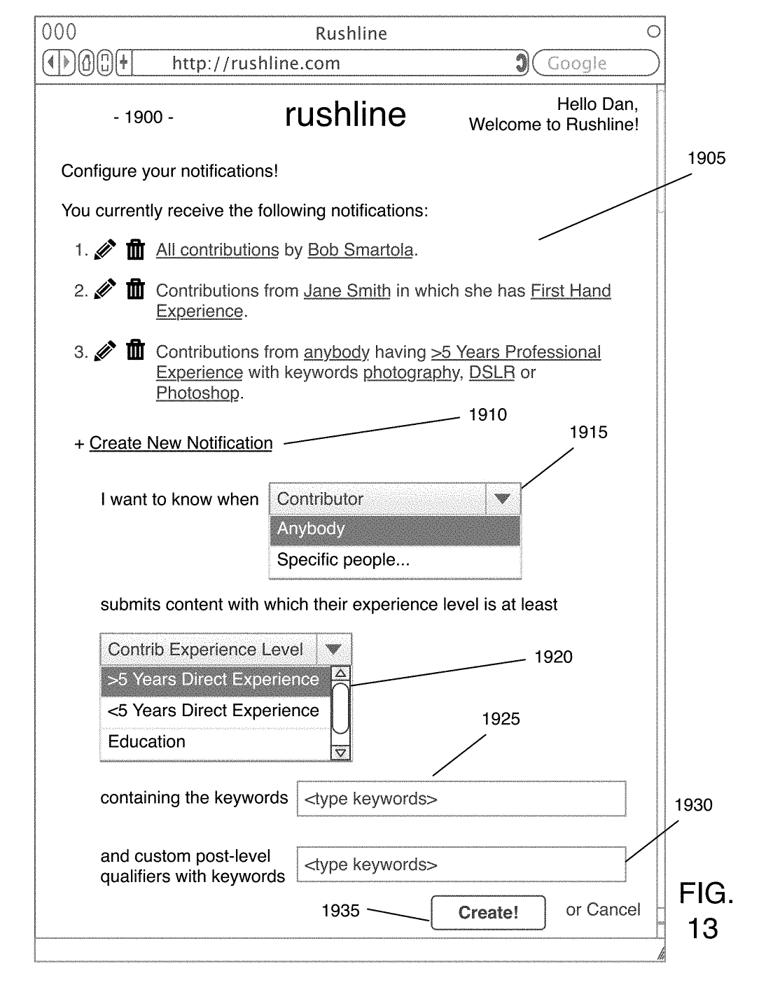

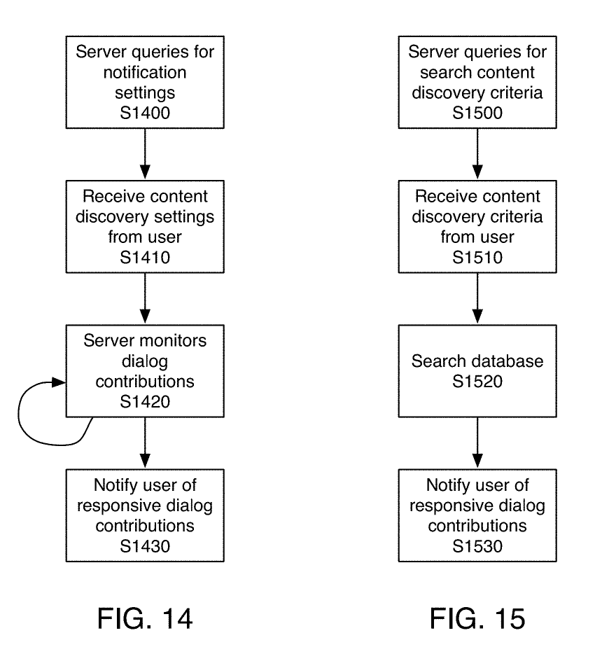

In implementation, FIG. 13 illustrates an exemplary user interface rendered on a user computing device via communication with server 100 and web server 106, for creating and managing user-configured notifications that can serve to link a user with dialogs of interest to them. FIG. 14 illustrates a process performed by server 100 for implementation of such dialog linker notifications. In step S1400, server 100 queries a user for notification settings. In the case of a user accessing the system via web browser, information is transmitted to render web page 1900 on the user's web browser. Web page 1900 includes region 1905 listing notifications currently active, and link 1910 initiating the creation of a new notification. The embodiment of FIG. 13 enables a user to specify content discovery settings that include one or more criteria for a notification, including content contributor (via selection element 1915), post-level experience qualifier (via selection element 1920), substantive content criteria such as post content keywords (via entry field 1925) and custom post-level qualifier keywords (via entry field 1930). In other embodiments, a content contributor notification criterion could be configured via a “zoom” setting analogous to that of control 1660 in FIG. 10 to specify a threshold level of association for inclusion in the notification (including, without limitation, association between the content contributor and the question originator, and/or association between the content contributor and the notification recipient). Once the content discovery settings are configured, a user can select button 1935 to submit the notification details to server 100 (step S1410). After content discovery settings for a notification are received by server 100, application logic 102 operates to regularly monitor new content postings against notification criteria in order to identify responsive content (step S1420). When new contributions responsive to the content discovery criteria are identified, server 100 can operate to notify the user of the new responsive content (step S1430). In some circumstances, notification can be achieved via push notification, e.g. transmitting by server 100 a message to a user via a designated communication channel (e.g. email, instant message, mobile app notification) in order to notify the user of the responsive content. In other circumstances, notification can be achieved by adding a notification of the responsive dialog contribution, which may include some or all of the substantive content of the contribution, to a user-specific feed of responsive dialog content, which may be conveyed by server 100 to a user device and rendered via a web browser or mobile app.

User-specified content discovery settings which include post-level experience qualifiers can also provide a powerful content search capability. Traditionally, Internet users often rely on search engines, such as Google™, to find content answering a specific question. However, content discovered via Internet search engines may be created for a variety of purposes and motivations. Some such content is created for purposes or marketing or promoting specific products, rather than from a fair and impartial perspective. Some content may be from high quality, reliable sources, while other content may be from lower quality, unreliable sources. While search engine service providers are continually trying to improve their search algorithms to maximize the quality of search results, partial interests on the Internet are working just as hard to “game the system” and promote their own interests.

Meanwhile, user-generated content, such as that generated on traditional question-and-answer sites, has the potential to provide a rich, searchable database of questions and answers that are highly granular in nature and consistent in form and format. However, traditionally, increasing breadth and level of user participation in such systems results in decreasing “signal to noise ratio”, with the most open and participatory systems having the worst problems with large proportions of unreliable or untrustworthy content.

By contrast, the system described herein can be implemented to provide a highly searchable repository of user-generated content, with broad participation and diverse subject matter, while also implementing effective indicators of reliability. Specifically, content discovery criteria such as those described in connection with FIGS. 13 and 14 can be utilized in a search query to identify desired content within a database of dialog contributions. Post-level experience qualifiers can be utilized as a search limiting criteria and/or search result ranking criteria, to prioritize dialog contributions in which the contributor has a greater level of experience or knowledge in the subject matter of the contribution. Furthermore, in embodiments in which questions are directed to specific recipients known to the asker, the relationship between the asker and question recipient provides yet a further level of reliability, both in the response substantive content and in the accuracy of the respondent's post-level experience qualifier selection.

FIG. 15 illustrates an exemplary process for implementation of a content search function by server 100. In step S1500, server 100 queries a user device for search content discovery criteria, including an experience level qualifier. The query can be implemented via, e.g., a web browser user interface analogous to that of FIG. 13. In step S1510, server 100 receives search content discovery criteria from the user. In step S1520, application logic 102 searches database 104 to identify dialog contributions responsive to the content discovery criteria received in step S1510. In step S1530, server 100 publishes a notification of dialog contributions that are responsive to the content discovery criteria received in step S1510. In some embodiments, the notification of step S1530 prioritizes dialog contributions based, at least in part, on the experience level qualifier of the responsive contributions, so that all other criteria being equal, contributions having a greater experience level qualifier are presented first. In some other embodiments, the notification of step S1530 prioritizes dialog contributions based, at least in part, on personal associations of the user performing the search, either as a result of being connected directly or through various degrees of separation, or as a result of having participated in mutual conversations in the past.

While certain system infrastructure elements are illustrated in particular configurations, it is understood and contemplated that functional elements described herein can be readily integrated and/or implemented via various alternative hardware or software abstractions, as would be known to a person of skill in the field of information systems design. For example, while some of the above described embodiments include presentation of content via a web browser, it is contemplated and understood that a standalone PC application, or a smart phone or tablet computer app, could be implemented in order to present content as described hereinabove. These and other variations are contemplated.

Moreover, while certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of any appended claims.

1. A computer-implemented method for one or more servers to facilitate a conversation amongst multiple participants communicating over one or more digital communication networks via a plurality of user devices, the method comprising:
receiving user-input from an opening user via communication between a user device and a server, the user-input originating a new conversation and comprising opening dialog content;
making said opening dialog content available via request to a networked database; and
receiving one or more responses to said opening dialog content from respondents, the responses comprising substantive content and an associated post-level qualifier, the post-level qualifier being (a) explicitly designated by the respondent exclusively for the substantive content with which it is associated, (b) descriptive of the respondent's personal level of qualification relative to the substantive content with which it is associated, and (c) being selected by the respondent from amongst a plurality of pre-determined options.

2. The method of claim 1, further comprising: publishing said opening dialog content and a subset of said one or more responses to a user device, the subset being determined based on the post-level qualifier associated with each response.

3. The method of claim 2, in which the step of publishing said opening dialog content and a subset of said one or more responses comprises the sub-steps of:
querying a viewer for a minimum post-level qualifier via network-based communication between said servers and one of said user devices associated with the viewer; and
only if at least one of said one or more responses is associated with a post-level qualifier that meets or exceeds said minimum post-level qualifier, publishing said opening dialog content and a subset of said one or more responses to the user device associated with the viewer, the subset being determined to include responses associated with post-level qualifiers that meet or exceed the minimum post-level qualifier.

4. The method of claim 1, in which the user-input from the opening user further comprises specification of a post-level qualifier descriptive of the opening user's personal experience level relative to the opening dialog content and being selected by the opening user from amongst said plurality of predetermined options.

5. The method of claim 1, in which the post-level qualifier descriptive of the respondent's personal level of qualification is determined based on a designation of the respondent's level of confidence in the substantive content contributed.

6. The method of claim 1, further comprising:
receiving specification of push notification criteria from a second user, at least one of said criteria being contingent on said post-level qualifiers; and
automatically transmitting one or more of said responses to the second user via push notification if the responses satisfy the push notification criteria.

7. The method of claim 1, further comprising:
receiving specification of push notification criteria from a second user, at least one of said criteria being contingent on said post-level qualifiers; and
transmitting information via the digital communication networks for rendering of a viewing user-specific feed on a user device associated with the viewing user, the feed comprising notification of content contributions matching the viewing user's push notification criteria.

8. The method of claim 6, in which the push notification criteria further include one or more keyword search terms.

9. The method of claim 7, in which the push notification criteria further include one or more keyword search terms.

10-19. (canceled)

20. A computer-implemented method for one or more servers to facilitate a conversation amongst multiple participants communicating over one or more digital communication networks via a plurality of user devices, the method comprising:
receiving one or more dialog contributions from user devices associated with contributors, the dialog contributions being posted to a searchable networked database, the dialog contributions including substantive content and an associated post-level qualifier, the post-level qualifier being (a) explicitly designated by its contributor exclusively for the substantive content with which it is associated, (b) descriptive of its contributor's personal level of qualification relative to the substantive content with which it is associated, and (c) being selected by the contributor from amongst a plurality of pre-determined options;
receiving networked communications from a viewing user comprising content-discovery settings, the content-discovery settings comprising substantive content criteria dependent upon the substantive content associated with the dialog contributions and a qualification level criterion dependent on the post-level qualifier associated with the dialog contributions; and
publishing notifications to the viewing user comprising notification of content contributions matching the viewing user's substantive content criteria and qualification level criterion.

21. The method of claim 20, in which the step of publishing notification to the viewing user comprises transmitting push notifications to an electronic contact address associated with the viewing user containing notification of content contributions matching the viewing user's substantive content criteria and qualification level criterion.

22. The method of claim 20, in which the step of publishing notification to the viewing user comprises transmitting information via the digital communication networks for rendering of a viewing user-specific feed on a user device associated with the viewing user, the feed containing notification of content contributions matching the viewing user's substantive content criteria and qualification level criterion.

23. The method of claim 20, in which the substantive content criteria comprises one or more keywords required to be present within the dialog contribution substantive content.

24. The method of claim 20, in which:
the dialog contributions further include one or more topic indicators associated with the dialog contribution substantive content and selected from amongst a predetermined set of topics; and
the substantive content criteria comprises one or more topics required to be associated with the dialog contribution.

25. The method of claim 20, in which:
said plurality of pre-determined options for post-level qualifier is organized in an ordered sequence; and
the qualification level criterion specifies a minimum value for the post-level qualifier within the ordered sequence.

26. The method of claim 20, in which:
the step of receiving network communications from a viewing user comprising content-discovery settings is comprised of the sub-step of querying a user device associated with the viewing user for search criteria, the search criteria comprising the substantive content criteria and the qualification level criterion; and
the step of publishing notifications to the viewing user comprises the sub-step of transmitting a search result to the user device associated with the viewing user, the search result comprising identification of dialog contributions for which the contribution's substantive content is responsive to the substantive content criteria and the post level qualifier associated with the contribution meets or exceeds the qualification level criterion.

27. The method of claim 20, in which:
the step of receiving network communications from a viewing user comprising content-discovery settings is comprised of the sub-step of querying a user device associated with the viewing user for push notification criteria, the push notification criteria comprising the substantive content criteria and the qualification level criterion; and
the step of publishing notifications to the viewing user comprises the sub-step of periodically transmitting to a user device associated with the viewing user notification of new dialog contributions having substantive content responsive to the substantive content criteria and a post level qualifier satisfying the qualification level criterion.

28. The method of claim 20, in which the step of receiving networked communications from a viewing user comprising content-discovery settings is comprised of first presenting the viewing user with a user-interface element enabling selection of a threshold value for said qualification level criterion.

29. The method of claim 28, in which said user-interface element is a slider control.
